(19) United States
(12) Patent Application Publication
(10) Pub. No.: US 2008/0148044 A1
(43) Pub. Date: Jun. 19, 2008

(54) LOCKING CARRIER ACCESS IN A COMMUNICATION NETWORK

(75) Inventors: Steven D. Upp, Bartlett, IL (US); Walter P. Goulet, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/612,532

(22) Filed: Dec. 19, 2006

(51) Int. Cl. H04L 9/00

(52) U.S. Cl. 713/156

(57) ABSTRACT

An apparatus and method for locking carrier access in a communication network, including a first step (102) of installing a pattern matching string in a mobile subscriber station. A next step (104) includes embedding a service provider identity within a subject of a digital certificate. A next step (106) includes receiving the digital certificate of the embedding step. A next step (108) includes performing network entry with the communication network. A next step (110) includes extracting the service provider identity from the digital certificate. A next step (112) includes utilizing the pattern matching string to match against the service provider identity

### FIELD OF THE INVENTION

The present invention relates generally to the field of communication networks, and more particularly, to authorized access to communications equipment in a communications network.

### BACKGROUND OF THE INVENTION

The IEEE 802.16-2005 standard (herein referred to as WiMAX) communication standard, among other packet data communication systems, can provide security features to prevent unauthorized users from accessing data on the network. These security features not only provide a measure of privacy for a user of the network, but also allows a service provider to establish some measure of control over access to its network.

One common technique to provide the above describe security features is to use a Public Key Infrastructure (PKI) to provide authentication and privacy of messaging on the network. For example, access terminals and authentication servers within the service network utilize the asymmetric properties of public key cryptography to authenticate the end points of the communication link to prove to each other that at least one end point in the communication path, has possession of a private key which is cryptographically associated with a public key that can be shared with the remote party. Typically a digital certificate is utilized by one or both of the end points of the communication link that contains an immutable set of attributes including the identity of the end point itself, the public key of the end point, and a signature from a certificate authority. Utilizing well known PKI based techniques the end point(s) can validate that a digital certificate is signed by a trusted certificate authority and that the remote party has possession of the private key the implication of which is that the identity of the remote party has been cryptographically validated.

However, there are limits to the ability of public key based authentication here, since any access network could possess a valid digital certificate signed by a trusted certificate authority. What is needed is a method in which the access terminal can differentiate the wireless networks based on the identity of the network as presented within the contents of the digital certificate itself and a mechanism by which the device can be configured to accept or deny communication based on the identity of one or more potential networks.

To solve this issue, service providers in a network can configure access terminals with profiles for a list of realms with which the terminal may complete network entry authentication in order to communicate on the network. IEEE 802.16 offers such authenticating services using a protocol called EAP (Extensible Authentication Protocol) of which support for public key authentication (PKI) based authentication methods for network access is possible.

Referring to FIG. 1, a flow chart is shown that describes existing EAP authentication protocols. A Mobile Subscriber Station (MSS) 10 is provided for communication on a WiMAX network. The MSS is pre-configured 14 with a list of Certificate Authority (CA) Root Certificates. These are trusted digital credentials identifying entities that have the authority to certify operation of the terminal on the network. The MSS is also configured with a defined list of one or more regular expression based realms. For example, an MSS may be configured with a network realm filter such as *.carrier.com. Service on the network for the MSS is authenticated by a Home Authentication, Authorization, Accounting (H-AAA) server 12. This server is configured 16 with Server Certificate issued by a carrier. The AAA Server Certificate also contains an associated Certificate Common Name (CN) in readable text (e.g. aaa1.carrier.com, aa2.west.carrier.com).

Upon an initial communication 18 from a terminal, the answering access point connects to the H-AAA server for authentication of the terminal. The access point only allows EAP packets between the MSS to the H-AAA, blocking all other data. H-AAA server sends 20 an EAP request message to start a particular authentication method through the access point to the MSS. The MSS replies 22 through the access point with a Client Hello message including its identity. The H-AAA server responds 24 with a Server Hello EAP packet containing the identity of the authentication server and its own Server Certificate. The above description has been simplified to exclude additional, non-pertinent information exchanged in the EAP protocols for the sake of brevity.

The MSS uses public key digital certificate based authentication techniques to validate 26 the H-AAA Server Certificate. In particular, the MSS validates the H-AAA Server Certificate by: a) verifying that the certificate is well formed, b) verifying that the certificate hasn't expired, and c) verifying that the certificate is issued by a trusted CA (i.e. one of the CA Root Certificates installed on the MSS). Assuming the H-AAA Server Certificate is valid (as shown), an EAP message is sent indicating that validation is Finished 28. Optionally, the MSS can cache 30 the H-AAA Server Certificate for further validation. Once the EAP authentication is successful 32, the access point is directed to authorize the client for other types of traffic, making the network entry complete.

It should also be noted that there are many types of EAP protocols that can be used for authentication. Some example EAP protocols that utilize server AAA digital certificates include, but are not limited to: EAP-TLS (Transport Layer Security), EAP-TTLS (Tunneled Transport Layer Security), PEAP (Password Extensible Authentication Protocol), each of which defines how authentication takes place.

At present, a WiMAX terminal may contain authentication profiles for many different carriers. This is a cost disadvantage to a carrier that provides a subsidized terminal to a user who then might use the terminal on a competing carrier's network. For example, terminals may be capable of utilizing different profiles for access to networks. However, an MSS that is ‘carrier-locked’ can utilize the identity of the network as validated by the H-AAA server certificate to determine if the MSS will accept the identity of the network prior to enabling data services and avoid accepting network connections from networks that are ‘not allowed’ by the carrier lock. It would therefore be preferred to have a carrier-supplied terminal “locked” to that carrier's network. The previously described technique for authentication does not provide a solution for carrier locking a subscriber unit as any H-AAA with a server certificate that can be authenticated through the use of the root certificate of the H-AAA's certificate hierarchy is pre-configured in the MSS.

Therefore, there is a need for a method and apparatus for a service provider to use a terminal's stored profiles to “lock” the subscriber terminal to their networks so that the terminal will only function on a network that is owned or affiliated with the service provider, similar to today's cellular service providers (e.g. Sprint, Verizon) that limit a cellular phone to operate on only that provider's network. In particular, carriers need a way to service provider lock a terminal so that the carrier can subsidize the cost of the device and yet be certain that the device can only be used with their network.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a simplified flow diagram of prior art EAP authentication;

FIG. 2 is a simplified flow diagram of modified EAP authentication, in accordance with the present invention; and

FIG. 3 is a simplified flow diagram of method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF THE PREFERRED EMBODIMENTS

The present invention provides a method and apparatus for a service provider to use a terminal's stored profiles to “lock” the subscriber terminal to a network that is owned or affiliated with the service provider. In this way, the terminal will only function with that network, and can therefore be subsidized by a carrier with the view of recouping their investment through network access fees. In particular, a service provider lock can be accomplished by configuring a mobile subscriber station (MSS) terminal to utilize PKI validated information to identify one or more network service providers, such that the terminal is only operable with that service provider's network. The configuring of the terminal can be performed at the factory of its manufacturing, or by a retailer or user after purchase, such as by means of online service provisioning, for example.

Although it is known for various PKI-based clients to allow for pattern matching of network certificates, the control of these pattern matches is based on a definition within the control of the end user. In contrast, the present invention describes a mechanism via a provisioning server within the network that is allowed to add and modify an authentication string for provisioning of service. This allows carriers to enable retail models and add subsidization of the device to their product offering.

The use of a strongly authenticated credential, such as a digital certificate from an AAA server to identify the network, enables the terminal with a service provider lock enabled to know with confidence the identity of the service provider. This identity can be used to make a determination of whether or not the terminal is permitted to provide data services on this network or not. The present invention uses flexible pattern matching on the contents of an authenticated network certificate to implement the network check, as will be detailed below. Applying a service provider lock across all authentication profiles within a device allows a service provider to offer differentiated service (locked and unlocked) and know with confidence what the user is able to do with the device.

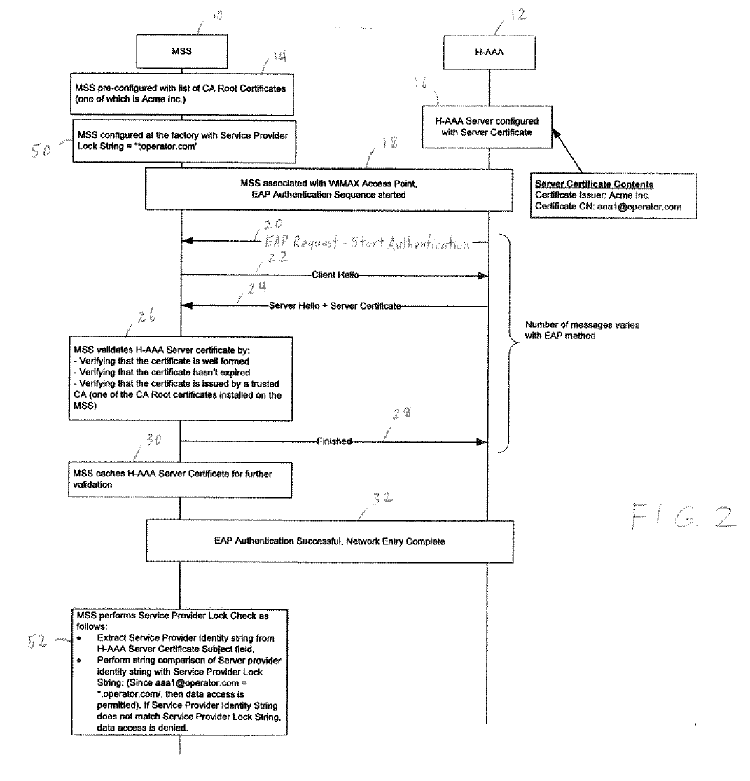

Referring to FIG. 2, a flow diagram is shown for a WiMAX communication system that utilizes Extensible Authentication Protocol (EAP)-based authentication. It should be noted that the present invention is equally applicable to several other EAP based authentication algorithms utilize digital certificates at the Home Authentication, Authorization, Accounting (AAA) server to enable a client device to authenticate the AAA server's identity. Some example EAP methods that utilize server AAA certificates includes, but is not limited to: EAP-TLS (Transport Layer Security), EAP-TTLS (Tunneled Transport Layer Security), PEAP (Password Extensible Authentication Protocol).

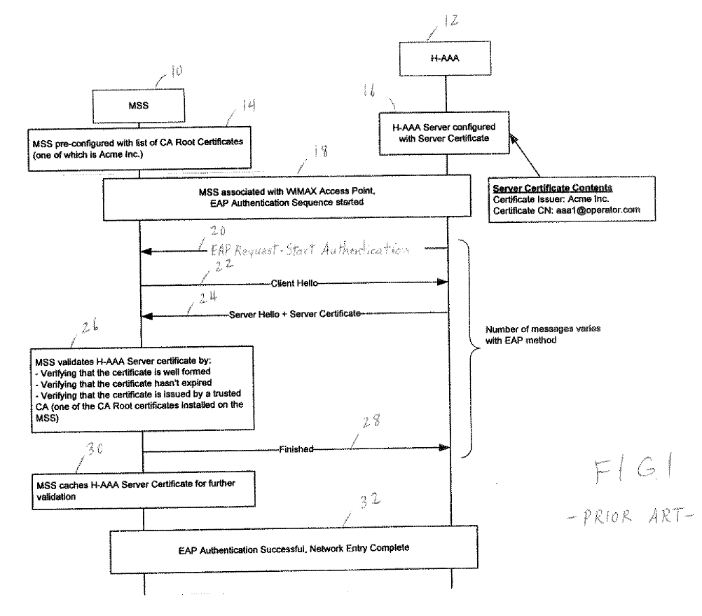

As in FIG. 1, the MSS 10 is pre-configured 12 with a list of CA Root Certificates. However, in accordance with the present invention, the MSS is also configured 50 with a Service Provider Lock String (e.g. “*.operator.com”) which is later used as a pattern matching string. The string can be installed in the MSS in various ways, as will be detailed below. Also, in accordance with the present invention, the H-AAA server 12 is configured 16 with a server certificate. In the present invention, the AAA server certificates have FQDNs (Fully Qualified Domain Name) embedded within them in readable text (e.g. aaa1.operator.com, aa2.west.operator.com). The FQDN serves as the service provider identity within a subject of a digital certificate.

Using the EAP authentication protocols 18, 20, 22, 24, as previous described for FIG. 1, and which will not be repeated here for the sake of brevity, a terminal communicates with the AAA in order to receive the digital certificate embedded with the service provider identity. Using a regular expression parser, the MSS can extract the FQDN from the digital certificate to provide the service provider identity.

The MSS, after having validated 26 that the digital certificate from the AAA is signed by a trusted Certificate Authority (e.g. VeriSign, WiMAX Forum, etc), proceeds to performing network entry with the communication network using EAP protocols 28, 30, 32 as previous described for FIG. 1, and which will not be repeated here for the sake of brevity. However, in accordance with the present invention, once the MSS has extracted the identify of the server from the certificate, the MSS can then utilizing 52 its stored pattern matching string to match against the service provider identity, and thereby allow locked service for the MSS on the network of the carrier.

In practice, the MSS is configure with a string containing a regular expression that can be used to perform a pattern match against the AAA server's PKI (Public Key Infrastructure) DNS (Domain Name System) identity. For example, the string can be;

```
    *.carrier.com
or a list of more than one regular expressions such as
    *.carrier1.com; *.carrier2.com; *.[east|west].carrieridentity.com
or a string such as
    *  // allow any service provider identity
```

The MSS performs a Service Provider Lock Check by extracting the service provider identity from the AAA server certificate's subject identity fields including but not limited to the Common Name, the subject alternate name (e.g. the Domain Name System Name, DNSName) or other attributes that contain the identity of the server. The MSS than performs a string comparison of the service provider identity against the service provider lock string. If the service provider identify from the AAA server certificate can be pattern matched according to the previously configured regular expression (e.g. aaa1,operator.com matches to *.operator.com) where in this case the ‘*’ character is a wildcard that would match ‘aaa1’, ‘aaa2’, etc, then data access is permitted on that carrier. However, if the service provider identify from the AAA server certificate can not be pattern matched according to the previously configured regular expression, then the terminal rejects the network and denies access to data services.

The service provider lock string can be installed in the MSS in various ways. In one case, the terminal is configured with service provider pattern lock string in the factory. This enables equipment in the factory to be service provider locked prior to shipment to end users.

In another case, the terminal is configured with service provider pattern lock string as part of an online provisioning process, which can be provided over a wireless or wired interface. For example, a user who signs up online with a service provider would initially have an AAA pattern lock string equal to ‘*’ to allow it to authenticate to any network. Then once the device is on that network and communicates with a provisioning service, the provisioning service can override the pattern to narrow the permitted pattern matches.

In yet another case, the terminal is configured with the service provider lock string as part of an offline provisioning process. For example, an installation compact disc provided by a service provider could execute on a host computer through a physical interface that guides the user through the activation process and configures the device with a service provider lock. Other offline wired or wireless processes could also be used.

In either case, the service provider lock string can be modified in the field after manufacture of the MSS to narrow or widen the pattern match to add or remove service provider locks on an as needed basis. For example, the lock string can be configured via a configuration program, or an installation piece of software after the MSS leaves its place of manufacture, such as the case where a distribution facility takes an unlocked device and locks it before packaging the product, or a retail case where a point of sale process results in the lock being applied before providing the product to the consumer. In this way, a set of operational profiles associated with a service provider lock string for a terminal can be defined as a sub-list of certificate authorities, which can be further limited by geographic area.

Once the device has been locked to a service provider the device must prevent unauthorized changes from being made to the service provider pattern lock. To accomplish this, the service provider pattern lock can again be used. In the online case, the device can strongly authenticate an online service again using the digital certificate of the network entity and validate that the server also possesses a valid server certificate with the same FQDN based pattern match before permitting an unlocking operation from occurring.

In both the offline and online case instructions to unlock or to replace the service provider lock string may be further protected by ensuring that the updated service provider string is digitally signed with a digital certificate whose identity again, is validated by the currently configured service provider pattern matching string.

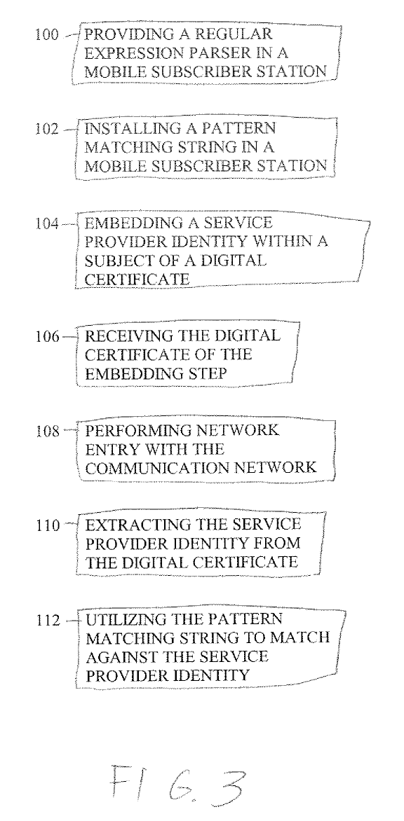

FIG. 3 illustrates a method for locking carrier access in a communication network. The method includes a first step 100 of providing a regular expression parser in a MSS.

A next step 102 includes installing a pattern matching string in a mobile subscriber station, by a service provider. This step can include installing the pattern matching string in a factory of manufacture of the mobile subscriber station.

Alternatively or additionally, this step can include installing the pattern matching string in the mobile subscriber station using an online provisioning process. For example, the online provisioning process can override any existing pattern matching string. In addition, the pattern matching string in the mobile subscriber station can be modified after provisioning of the mobile subscriber station to be wider or narrower in scope.

A next step 104 includes embedding a service provider identity within a subject of a digital certificate. Preferably, the service provider identity is a Fully Qualified Domain Name (FQDN). More preferably, the service provider identity is an Authentication, Authorization, Accounting (AAA) server's Public Key Infrastructure (PKI) Domain Name System (DNS) identity.

A next step 106 includes receiving the digital certificate of the embedding step.

A next step 108 includes performing network entry with the communication network.

A next step 110 includes extracting the service provider identity from the digital certificate.

A next step 112 includes utilizing the pattern matching string to match against the service provider identity. When a match is found, access is locked to that carrier identified in the service provider lock string. If a match is not found, access is denied to that network.

The present invention has broad applications in new wireless architectures that are IP based, such as WiMAX, CDMA-1× and EvDO architectures. The present invention takes advantage of the already established EAP authentication techniques in a new way to carrier-lock a mobile subscriber station to a particular service provider.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for locking carrier access in a communication network, the method comprising the steps of:
installing a pattern matching string in a mobile subscriber station;
embedding a service provider identity within a subject name of the network's digital certificate;
receiving the digital certificate of the embedding step; and
performing network entry with the communication network;
extracting the service provider identity from the digital certificate; and
utilizing the pattern matching string to compare against the extracted service provider identity to determine whether or not the device will associate with the network.

2. The method of claim 1, further comprising the step of providing a regular expression parser for use in the extracting step.

3. The method of claim 1, wherein the service provider identity is a Fully Qualified Domain Name (FQDN) of the AAA.

4. The method of claim 1, wherein the matching step includes utilizing the pattern matching within the mobile subscriber station with an Authentication, Authorization, Accounting (AAA) server's identity contained within a digital certificate.

5. The method of claim 1, wherein the installing step includes installing the pattern matching string in a factory of manufacture of the mobile subscriber station.

6. The method of claim 1, wherein the installing step includes installing the pattern matching string in the mobile subscriber station after manufacture of the mobile subscribing station using an online provisioning process.

7. The method of claim 1, wherein the installing step includes installing the pattern matching string in the mobile subscriber station after manufacture of the mobile subscribing station using an offline process.

8. The method of claim 1, wherein the installing step includes installing the pattern matching string in the mobile subscriber station after manufacture of the mobile subscribing station, and wherein the installing of the pattern matching string overrides any existing pattern matching string.

9. The method of claim 1, wherein the pattern matching string in the mobile subscriber station can be modified after provisioning of the mobile subscriber station only when the entity initiating the modification can be validated as having been authorized for the modification of the pattern matching string.

10. The method of claim 9, wherein the modified pattern matching string is digitally signed with a digital certificate whose identity is further validated by the currently configured service provider pattern matching string.

11. A system for locking carrier access in a communication network, the system comprising:
a service provider provides a service provider lock string for use as a pattern match string;
an authentication server embeds an identity of the service provider within a subject of a digital certificate; and
a mobile subscriber station upon which the pattern matching string is installed, the mobile subscriber station receives the digital certificate from the authentication server, performs network entry with the communication network, extracts the service provider identity from the digital certificate; and utilizes the pattern matching string to compare against the extracted service provider identity to determine whether or not the device will associate with the network.

12. The system of claim 11, wherein the mobile subscriber station includes a regular expression parser to extract the identity from the digital certificate.

13. The system of claim 11, wherein the service provider identity is a Fully Qualified Domain Name (FQDN).

14. The system of claim 11, wherein the mobile subscriber station pattern matches the lock string against the authentication server's subject name and subject alternative name extensions.

15. The system of claim 11, wherein the pattern matching string can be installed in the mobile subscriber station at factory of manufacture thereof.

16. The system of claim 11, wherein the pattern matching string can be installed in the mobile subscriber station using an online provisioning process after manufacture of the mobile subscribing station.

17. The system of claim 11, wherein the pattern matching string can be installed in the mobile subscriber station using an offline provisioning process after manufacture of the mobile subscribing station.

18. The system of claim 11, wherein the pattern matching string can be installed in the mobile subscriber station after manufacture of the mobile subscribing station such that the pattern matching string overrides any existing pattern matching string.

19. The system of claim 11, wherein the pattern matching string in the mobile subscriber station can be modified after provisioning of the mobile subscriber station only when the entity initiating the modification can be validated as having been authorized for the modification of the pattern matching string.

20. The method of claim 19, wherein the modified pattern matching string is digitally signed with a digital certificate whose identity is further validated by the currently configured service provider pattern matching string.
